(19) United States
(12) Patent Application Publication
(10) Pub. No.: US 2005/0030938 A1
(43) Pub. Date: Feb. 10, 2005

(54) Methods and systems for least cost routing of communications providing low dollar amount cards

(76) Inventor: Harold Barr, New York, NY (US)

Correspondence Address: JENNIFER MEREDITH, 315 PARK AVENUE SOUTH, FLOOR 19, NEW YORK, NY, 10010, US

(21) Appl. No.: 10/635,335

(22) Filed: Aug. 5, 2003

(51) Int. Cl. H04L 12/28

(52) U.S. Cl. 370/352; 379/114.01

(57) ABSTRACT

The present invention provides systems and methods for routing a communications (such as a telephone call) through the most cost effective route. The method may comprise the steps of: determining the cost per minute and complexity in routing said call from an origin to a destination through Internet telephony; determining the cost per minute and complexity in routing said call from an origin to a destination through time division multiplexed (TDM); routing said call through either said Internet telephony or said time division multiplexing (TDM) according to said cost per minute and said complexity of route.

### BACKGROUND OF THE INVENTION

The present invention relates to method and systems for international pre-paid phone cards, including low currency denominations, which relies on a system of routing calls through the least cost route. This allows the provider to use either an Internet telephony gateway or traditional time division multiplexing (TDM) to route the telephone calls. This provides a radically lower price than presently marketed phone cards, obviously appealing to consumers with a lower budget. Consumers are able to recover the funds invested in a card faster since the stored value remains with the end user. This promotes a faster recycling of business, fostering a positive situation for the manufacturer, vendors, distributors and consumers

The current market employs a plethora of phone cards in many denominations. The most common method of connecting these calls is through calling an enhanced featured platform where the user enters a pin or identification number of some sort, the caller is also prompted to enter the number they are attempting to connect with. From the pin or identification number the balance of their account is confirmed and then the call is connected, providing significant funds remain in the account to make the desired connection.

The process of routing a telephone call in the traditional manner is often pricey. Thus requiring a per minute rate high enough to make a one dollar phone card an unappealing option to consumers, as they would not receive a duration of connection long enough to justify purchasing a one dollar card, especially for international calling. One option for reducing the costs associated with traditional telephone connections is the use of Internet telephony.

Internet telephony, as disclosed in U.S. Pat. No. 6,597,686, issued to Smyk, is two way voice communication over a packet switched network, such as the Internet. To establish voice communication over the Internet using currently available Internet technology, each participant in a voice call must have a computer equipped for Internet access and special hardware and software supporting Internet voice communication, which may include a modem, TCP/IP software, a dialer, a sound card, a microphone, and a speaker to be suitably configured for Internet telephony. Naturally there are certain limitations and drawbacks associated with such a system.

To obtain Internet telephony service using an Internet telephony equipped computer, the parties to a call must connect to an Internet Service Provider providing access to the Internet. Accordingly, the customer would need an account with any of the various Internet Service Providers (i.e. America Online, MSN, Broadband or High Speed connection) available. The nature of most Internet Service Providers accounts requires account holders to pay a flat fee for Internet access. This access, when connected to a properly equipped computer can include engaging in voice communication with other comparably equipped computers over the Internet without incremental usage charges, as are present in traditional telephone billing systems. The advantage of using this type of system for voice communication via Internet telephony according to current billing methods is the insensitivity of the cost of calls to their duration.

As stated supra, both the calling and receiving party must have a computer properly equipped for voice communication, and connected to Internet at the time the call is initiated. Furthermore the interoperability of the Internet telephony software packages is also an issue, as certain vendors' Internet telephony software is not cross compatible with others'. Further compounding these issues is the fact that the sound quality of Internet telephony calls is generally worse than the sound quality of calls transmitted through the public switched telephone network (PSTN), using a system of time division multiplexing (TDM). In light of these issues a system for facilitating an Internet telephony call where one or both of the calling parties are not equipped for this type of connection is necessary.

In the case where one or both parties are not suitably equipped for such a call the use of an Internet telephone gateway is employed. An advantage of using Internet telephony gateways to provide voice communication over the Internet is that this type of system fosters the integration of the calling and called parties' regular telephone service with an intermediary which has the ability to support Internet telephony. Neither party requires special computer equipment or an Internet service provider account. Moreover, for one party to place an Internet voice call through the Internet using Internet telephony gateways, neither the calling nor called party are required to be logged onto the Internet.

Addressing some of the inherent limitations of fostering telecommunication via the Internet imposed by using the Internet and the necessary Internet telephony-capable computer hardware and software, many vendors have developed Internet telephony gateways. It has become desirable for a company such as one who sells phone cards to have the ability to route a call through Internet telephony which is coming from a caller that subscribes solely to common telephone service. Such a system requires the use of an Internet telephony gateway. An Internet telephony gateway would include a system capable of processing voice signals, namely including packetizing and depacketizing the voice data stream for transmission via the Internet between the incoming or outgoing traditional telephone system.

To establish an Internet telephony call through an Internet telephony gateway network, a phone call originator dials from a telephone number assigned to an Internet telephony gateway. The gateway then handles verifying any required account information (i.e. account number, remaining balance) and based on the destination the caller is attempting to connect with, determines the network address of the Internet telephony gateway providing the most cost efficient path to the dialed party. The Internet telephony gateway proceeds to connect the call via Internet telephony. When the called party answers the telephone, a communication path is established through the network between the two telephones. Additionally Internet gateways can be employed in the reverse manner, converting the packets present in an Internet telephony message back to a traditional TDM format, in the case where a TDM path is the most cost efficient for the vendor.

This type of system specifically allows a phone card vendor to inexpensively connect multiple calls while billing using a traditional per minute rate, as commonly accepted in the industry. Often the high prices on phone cards are to account for the per minute rate charged to the vendor for routing a call through a hardwire TDM network, coupled with a variety of additional fees associated with each connection. These fees can range from a connection or disconnection fee, to a membership, application or usage fee, often these fees alone exceed one dollar for each connection made through the phone card. The present invention through the use of least cost routing paired with the ability to use either TDM or Internet telephony to lower incurred costs, allows the vendor to abandon the use of any sort of fee other than the standard per minute billing of each telephone call, thus allowing cards of such a small denomination to be marketed.

### SUMMARY OF THE INVENTION

The present invention generally relates to a method for connecting two-way communications, generally voice communications, and more typically telephone calls. These communications are connected through an intermediate vendor and billed over a debit phone card in the preferred embodiment of the present invention. The calls are connected through the carrier providing the least cost route. Additionally the cards are often sold in low dollar denominations due to the ability to connect calls in such a cost effective manner.

According to one embodiment, this pertains to a method for handling billing on a phone card, comprising the steps of receiving a phone call from a customer with an origin and destination phone number. The price per minute rate is determined for the current call across at least two providers. Options for routing the call include at least one provider with the ability to transmit a call using Internet telephony and at least one provider with the ability to transmit a call using a time division multiplexed (TDM) transmission. The user's account must be verified to have sufficient funds before the call can be completed. Once the account has been verified the call is routed across the least cost route and the appropriate per minute rate is deducted from the user's account.

Another embodiment describes a method of routing a telephone call through the most cost effective provider. This is facilitated by means of first determining the cost of routing the call through Internet telephony, and then the cost transmitting a TDM signal. The call is then connected through the most inexpensive route. However in the case where there is not a clear difference in price between Internet telephony routing or TDM routing the complexity of the connection path will be considered as a factor in the decision to choose one means of fostering the connection over another.

These cards must be distributed to various vendors by means of a secure distribution method, as once the cards are activated they are immediately valuable, thus making them very susceptible to theft. One embodiment of the present invention involves a method of securely distributing the cards in groups, referred to as batches. Inactive batches of cards are then distributed to resellers. The payment for each batch, from each respective reseller is held in an escrow account, as a security deposit, and once this payment is secured the batch of cards receives a pre-activation. At this point it is the reseller's responsibility to secure the cards from theft, as the individual cards are activated upon their first use and upon activation the reseller's escrow account is debited by the value of the card used.

An alternate embodiment is that of a system that handles cost efficient routing of a communication, commonly a voice communication and more specifically a telephone call. The system includes a user account, and identification numbers associated with both an origin and destination device. Most commonly the origin and destination devices are telephones and the identification numbers associated with them are telephone numbers. The remaining balance on the user's account is verified through the input of an identification number. The cost of making the connection is analyzed across both TDM and Internet telephony using multiple providers. A computer-implemented program chooses the least cost route based solely on the cost of the connection. If further parameters are needed to make such a decision the complexity of the route is then analyzed.

This summary is not to be taken in a limiting sense, but is made merely for the purpose of illustrating the general principles of the invention, since the scope of the invention is best defined by the appended claims.

### BRIEF DESCRIPTION OF THE DRAWINGS

FIG. 1 is a flowchart of a method according to the present invention;

FIG. 2 depicts a flowchart of a method according to the present invention;

FIG. 3 depicts a flowchart of a method according to the present invention;

FIG. 4 depicts a flowchart of a method according to the present invention; and

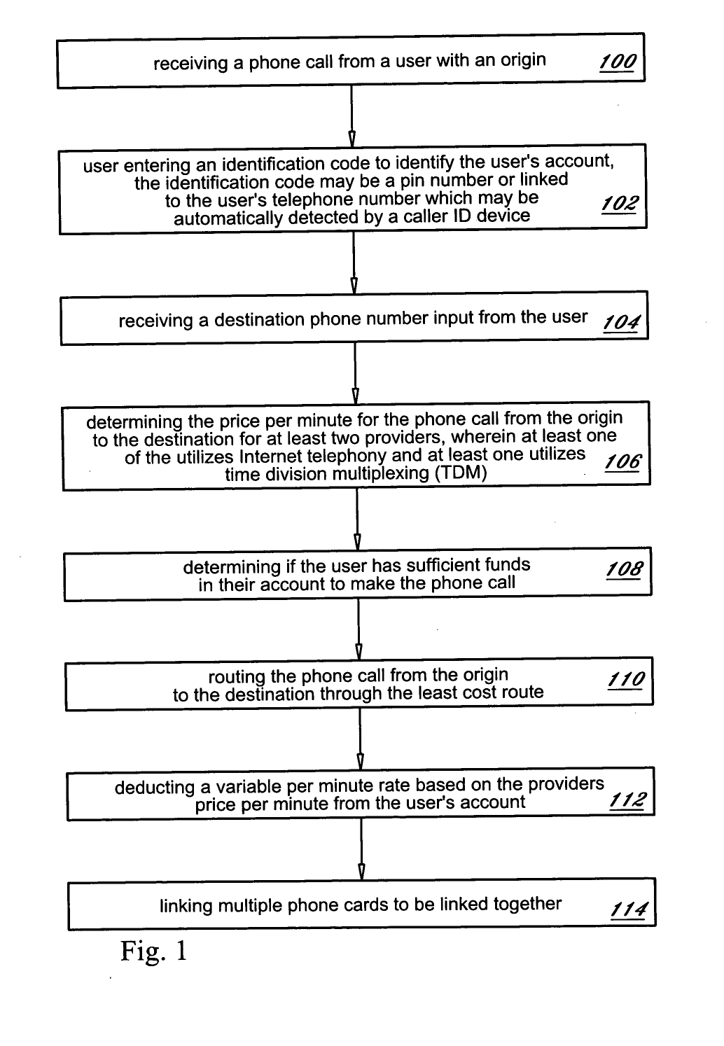

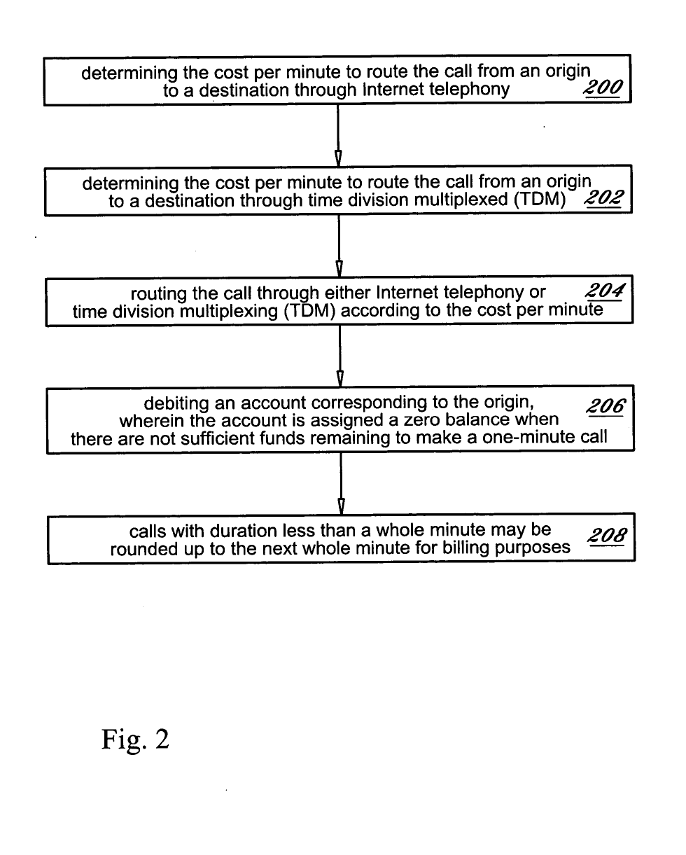

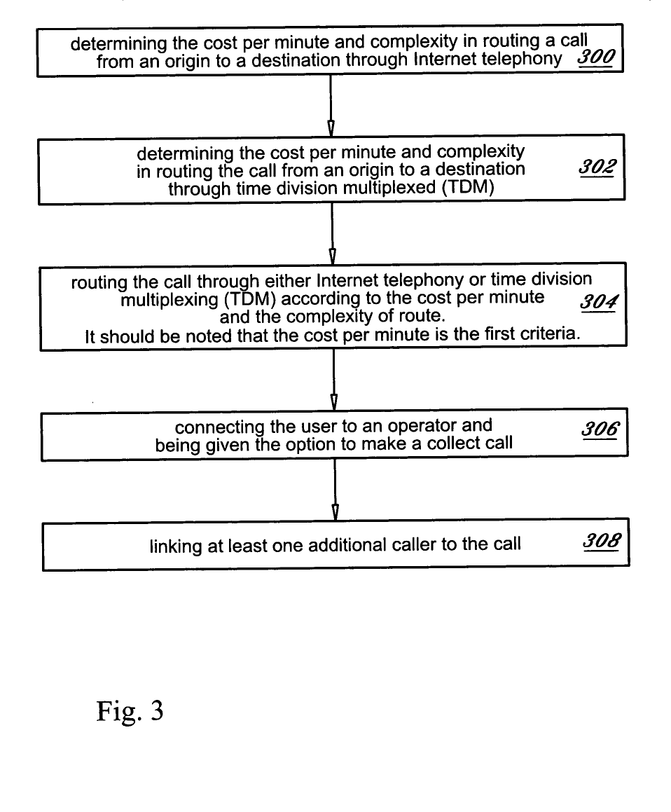

FIG. 1 depicts a system according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

FIG. 1 depicts a method of billing a phone card comprising the steps of: Step (100) receiving a phone call from a user with an origin, step (102) user entering an identification code to identify the user's account, the identification code may be a pin number or linked to the user's telephone number which may be automatically detected by a caller ID device; step (104) receiving a destination phone number input from the user; (106) determining the price per minute for the phone call from the origin to the destination for at least two providers, wherein at least one of the utilizes Internet telephony and at least one utilizes time division multiplexing (TDM). It should be noted that the origin telephone number may be the identification code and this may be automatically detected by a caller ID type device. Step (108) determining if the user has sufficient funds in their account to make the phone call; (110) routing the phone call from the origin to the destination through the least cost route; (112) deducting a variable per minute rate based on the providers price per minute from the user's account; (114) linking multiple phone cards to be linked together, thereby increasing the amount of time available for the calls. It is understood that the user has typically purchased the phone card, although they may be distributed as promotional items, wherein a third party has secured a payment for the phone card. Whereas previously, phone cards have used TDM or Internet telephony, the present invention provides for a method wherein the least cost route which includes at least one of the two types is utilized. It should be understood, though, that various other methods of carrying audio signals may be utilized. However, very quickly, the least cost route is determined and the call connected from the origin to the destination. This allows the phone card to be sold in low dollar amount denominations. For instance, cards may be sold in one dollar amounts. Calls with duration less than a whole minute are rounded up to the next whole minute for billing purposes. Also, the user's account is assigned a zero balance when there are not significant funds remaining to make a one-minute call. This is significant because in order to provide for low dollar amount (e.g. one dollar) phone cards, marginal amounts cannot be used and provide for income. In the event a user attempts to make a call when their card has insufficient funds available to connect such a call, one embodiment connects the caller to an operator who can facilitate a collect call for the user. They may also use a credit card or previously established account to replenish the card. However, whereas previously with larger dollar amount cards skimming (unbeknownst to the customer) was commonplace, the present invention informs the customer of the practice of rounding, rather than skimming. To link multiple cards together there must be enough remaining funds among all the cards to make a single call. According to one embodiment, this process can be accomplished over the Internet. For example, if the user has one card with four cents remaining, and another with fifty cents remaining the two can be merged onto a single card with a balance of fifty-four cents. Also, it may be desirable to allow the user the to link at least one additional caller to the call. For instance, a prompt, such as *77 allows, the user to dial another number and bring a second destination number into the conversation. The user may press *77 again to bring in another caller, so that four callers are now on the same telephone conversation. One embodiment includes the user entering an identification number, or pin number to identify their account. This could be done by entering in a number on the telephone, or by linking the identification number to the caller's telephone number which could be automatically detected through the use of a caller identification system.

According to yet another embodiment, a method of routing a telephone call through the most cost effective provider is disclosed, the method comprising the steps of: (200) determining the cost per minute to route the call from an origin to a destination through Internet telephony; (202) determining the cost per minute to route said call from an origin to a destination through time division multiplexing (TDM); (204) routing the call through either Internet telephony or time division multiplexing (TDM) according to the cost per minute using a method of least cost routing. This method may further comprise the step (206) debiting an account corresponding to the origin, wherein the account is assigned a zero balance when there are not sufficient funds remaining to make a one-minute call. In the event there is not sufficient funding to make another call one embodiment connects the user to an operator who can facilitate a collect call. Step (208) calls with duration less than a whole minute may be rounded up to the next whole minute for billing purposes. This call, once connected, in another embodiment, can have at least one additional party linked to the call. Where linking the additional party is intended to denote connecting a third party to the previously established connection between the caller and initial called party.

According to yet another embodiment, a method of routing a telephone call through the most cost effective provider is disclosed, the method comprising the steps of: (300) determining the cost per minute and complexity in routing a call from an origin to a destination through Internet telephony; (302) determining the cost per minute and complexity in routing the call from an origin to a destination through time division multiplexed (TDM); (304) routing the call through either Internet telephony or time division multiplexing (TDM) according to the cost per minute and the complexity of route. It should be noted that the cost per minute is the first criteria. That is, where one route is cheaper than another route, that route should be chosen. However, where both routes are equal, the next set of criteria used to choose the route is the complexity of the route. The complexity of the route may best be defined as the number of stops that a phone call has to take in order to properly route the call to the destination. For instance, if a call has New York as the origin and London as the destination, and a number of different routes are available, each at a cost of 2 cents per minute, it is desirable to pick the least complex route. That is, a direct route from New York to London is more desirable than a phone call that is routed New York to Boston, Boston to Los Angeles, Los Angeles to London. However, location is not the only factor in determining the complexity of the route. As stated previously, calls with duration less than a whole minute are rounded up to the next whole minute for billing purposes. Also, an account or phone card may be assigned a zero balance when there are not sufficient funds remaining to make a one-minute call. As stated supra, in the event a call is attempted with insufficient funds on the account, one embodiment would connect the caller to an operator who can foster a collect call to the desired destination. Additionally, once the call is connected, another embodiment can have at least one additional party linked to the call. According to another embodiment, the method may also comprise the step (306) connecting the user to an operator and being given the option to make a collect call. This may be ideally done when the card is down to one minute remaining, the caller may be connected to an operator who may recharge the card with an account or password. Step (308) linking at least one additional caller to the call. This may be desirable for a chat party or teleconference. In this way, the caller may easily conference in a number of people without using complicated call in services.

The present invention envisions a unique manner in which to securely distribute cards using the previously mentioned methods. Specifically, a method of securely distributing telephone cards in batches is envisioned. The method comprising the steps of: step (350) producing a batch of inactive cards, comprised of a group of individual inactive cards (e.g. 100 individual phone cards); (352) setting up an escrow account for the reseller for the receipt of funds; (354) distributing the batch of inactive cards to a reseller; (356) holding payment for the batch of cards from the reseller in an escrow account; (358) pre-activating the batch of inactive cards upon receipt of batch by reseller; (360) individually activating each of the pre-activated cards upon first use; (362) debiting the reseller's escrow account a predetermined amount upon activation of each of the pre-activated cards. Optionally step (364) may be assigning each individual card of the batch an identification number. Ideally, the identification number should be consecutive numbers. For example, a batch of 100 cards may be distributed with identification numbers between 1,000,100-1,000,199. In this way, the cards may be tracked. According to a preferred embodiment, the cards may be consecutively number, i.e. 1,000,100, 1,000,101, 1,000,102.

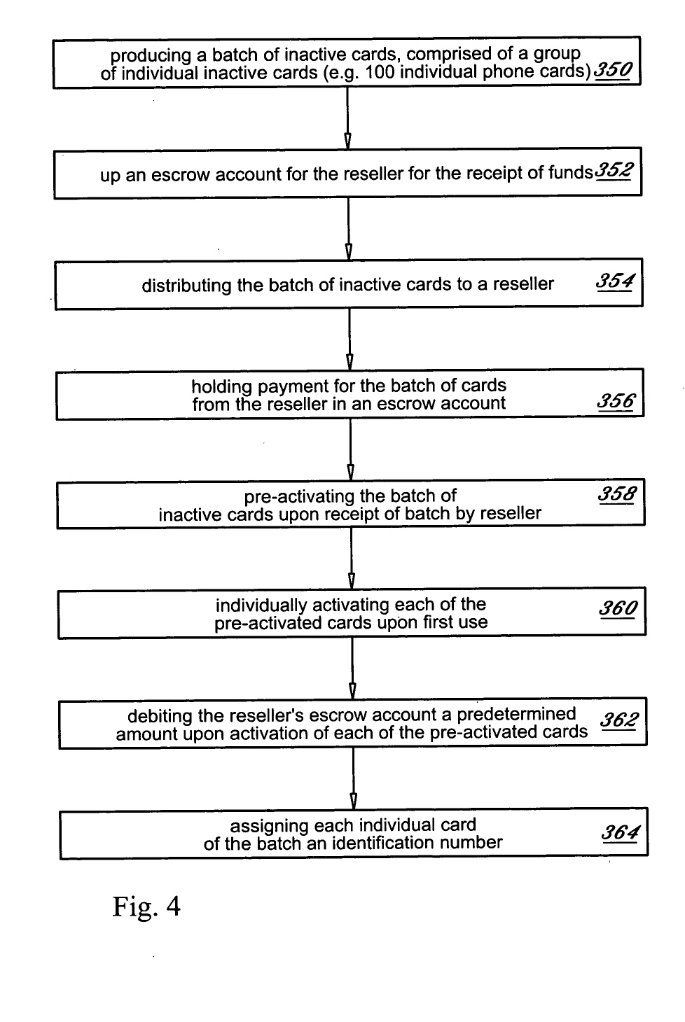

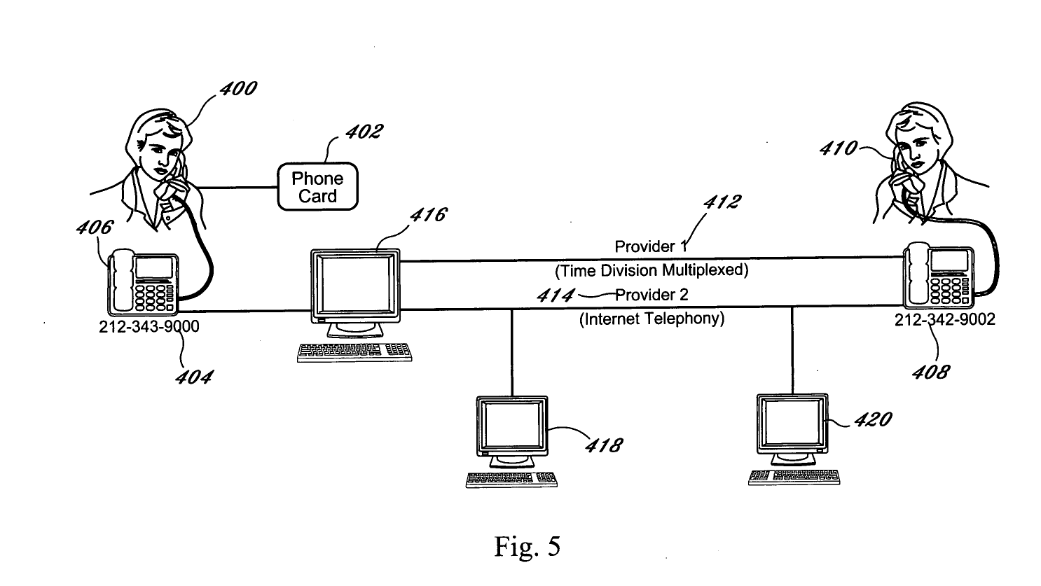

FIG. 4 depicts a system for cost efficient routing of a communication from a user. The system comprising: a user account (which may be printed on a phone card 402) linked to the user 400; a number (404) associated with an origin communication device (406); a number (408) associated with a destination communication device (410); an identification number associated with user's account, wherein the identification number is able to retrieve the remaining balance of the user's account. It should be understood that the user account and identification number may be printed on a phone card as distributed. The phone card may contain information about the users account, and may for instance be capable of automatically recharging a credit card and refilling the minutes. However, with the proliferation of Internet purchasing of phone minutes, it may be distributed via email or a webpage. At least two available providers, depicted as provider 1 (412) and provider 2 (414) wherein at least one of the at least two available providers has the ability to transmit communication across a time division multiplexed (TDM) system and at least one of the at least two available providers has the ability to transmit the communication across an Internet telephony system; a computer (416) implemented program for choosing from the at least two available providers (e.g. 412, 414) based on at least one characteristic of provider. The characteristic may be the lowest cost or the least complex route or any other number of characteristics including clarity. When the computer implemented system chooses Internet telephony, there may be a means (e.g. computer 418) of converting the communication data from TDM data to Internet telephony packets and a means (e.g. computer 420) of converting the communication data from Internet telephony packets to TDM data. However, some systems may not require such conversion, such as newly developed Internet telephony communication devices. According to the embodiments depicted, the origin communication device (406) and he destination communication device (410) are both telephones. However, they may be pagers, data messaging, etc. Also, as depicted, the number associated with the origin communication device (406) and destination communication device (410) is a telephone number. The telephone number of the origin communication device (406) may be automatically detected by caller ID and may also act as the identification number. Also, it should be understood that identification number may not be a telephone number, but rather, may be an IP address. For the purposes of billing, calls less than one minute may be automatically charged as one minute. Also, the user's account may be assigned a zero balance when there are not significant funds remaining to make a one-minute call.

1. A method of billing a phone card, said method comprising the steps of:
receiving a phone call from a user with an origin;
receiving a destination phone number input from said user;
determining the price per minute for said phone call from said origin to said destination for at least two providers, wherein at least one of said at least two providers utilizes Internet telephony and at least one of said at least two providers utilizes time division multiplexing (TDM);
determining if said user has sufficient funds in their account to make said phone call;
routing said phone calls from said origin to said destination through the least cost route; and
deducting a variable per minute rate based on said providers said price per minute from said user's said account.

2. A method as in claim 1, wherein said phone card is sold in low dollar amount denominations.

3. A method as in claim 1, wherein said phone card is sold in one dollar denominations.

4. A method as in claim 1, further comprising the step of:
linking multiple phone cards together, thereby increasing the amount of time available for said calls.

5. A method as in claim 4, wherein cards can be linked together over the Internet by cardholders.

6. A method as in claim 1, further comprising the step of:
said user entering an identification code to identify said user's said account.

7. A method as in claim 5, wherein said identification code is a pin number.

8. A method as in claim 5, wherein said identification code is linked to said user's telephone number.

9. A method as in claim 8, further comprising the ability of automatic detection of said caller's telephone number through the use of a caller identification system.

10. A method as in claim 1, wherein said calls with duration less than a whole minute are rounded up to the next whole minute for billing purposes.

11. A method as in claim 1, wherein said user's said account is assigned a zero balance when there are not significant funds remaining to make a one-minute call.

12. A method as in claim 11, further comprising the step of connecting said user to an operator and being given the option to make a collect call.

13. A method as in claim 1, further comprising the step of linking at least one additional caller to said call.

14. A method of routing a telephone call through the most cost effective provider, said method comprising the steps of:
determining the cost per minute to route said call from an origin to a destination through Internet telephony;
determining the cost per minute to route said call from an origin to a destination through time division multiplexed (TDM);
routing said call through either said Internet telephony or said time division multiplexing (TDM) according to said cost per minute.

15. A method as in claim 14, further comprising the step of debiting an account corresponding to said origin, wherein said account is assigned a zero balance when there are not sufficient funds remaining to make a one-minute call.

16. A method as in claim 15, further comprising the step of connecting said user to an operator and being given the option to make a collect call.

17. A method as in claim 14, further comprising the step of rounding up to the next whole minute wherein said call is less than a whole minute.

18. A method as in claim 14, further comprising routing said calls through the least cost route.

19. A method as in claim 14, further comprising the step of linking at least one additional caller to said call.

20. A method of routing a telephone call through the most cost effective provider, said method comprising the steps of:
determining the cost per minute and complexity in routing said call from an origin to a destination through Internet telephony;
determining the cost per minute and complexity in routing said call from an origin to a destination through time division multiplexed (TDM);
routing said call through either said Internet telephony or said time division multiplexing (TDM) according to said cost per minute and said complexity of route.

21. A method as in claim 20, wherein said calls with duration less than a whole minute are rounded up to the next whole minute for billing purposes.

22. A method as in claim 20, wherein said phone card is assigned a zero balance when there are not sufficient funds remaining to make a one-minute call.

23. A method as in claim 22, further comprising the step of connecting said user to an operator and being given the option to make a collect call.

24. A method as in claim 20, further comprising routing said calls through the least cost route.

25. A method as in claim 20, further comprising the step of linking at least one additional caller to said call.

26. A method of securely distributing telephone cards in batches, said method comprising the steps of:
producing a batch of inactive cards, comprised of a group of individual inactive cards;
setting up an escrow account for a reseller for the receipt of funds;
distributing said batch of inactive cards to said reseller;
holding payment for said batch of cards from said reseller in said escrow account;
pre-activating said batch of inactive cards upon receipt of batch by reseller;
individually activating each of said pre-activated cards upon first use;
debiting said reseller's said escrow account a predetermined amount upon activation of each of said pre-activated cards.

27. A method as in claim 26, further comprising the step of assigning each individual card of the batch an identification number.

28. A method as in claim 26 wherein said identification numbers for said batch of cards are consecutive numbers.

29. A system for cost efficient routing of a communication from a user, said system comprising:
a user account linked to said user;
a number associated with an origin communication device;
a number associated with a destination communication device;
an identification number associated with said user's account, wherein said identification number is able to retrieve the remaining balance of said user's account;
at least two available providers, wherein at least one of said at least two available providers has the ability to transmit said communication across a time division multiplexed (TDM) system and at least one of said at least two available providers has the ability to transmit said communication across an Internet telephony system;
a computer-implemented program for choosing from said at least two available providers based on at least one characteristic of said provider.

30. A system as in claim 29, further comprising a means of converting said communication data from TDM data to Internet telephony packets.

31. A system as in claim 29, further comprising a means of converting said communication data from Internet telephony packets to TDM data.

32. A system as in claim 29, further comprising a phone card, wherein said phone card contains information about said user account.

33. A system as in claim 29, wherein said origin communication device is a telephone.

34. A system as in claim 29, wherein said destination communication device is a telephone.

35. A system as in claim 29, wherein said number associated with said origin communication device is a telephone number.

36. A system as in claim 29, wherein said number associated with said destination communication device is a telephone number.

37. A system as in claim 29, wherein said identification code is a pin number.

38. A system as in claim 29, wherein said identification code is linked to said caller's telephone number.

39. A system as in claim 38, wherein said computer implemented program further comprises a caller identification system for automatic detection of telephone number associated with said origin phone device.

40. A system as in claim 29, wherein said calls with duration less than a whole minute are rounded up to the next whole minute for billing purposes.

41. A system as in claim 29, wherein said user's said account is assigned a zero balance when there are not significant funds remaining to make a one-minute call.

42. A system as in claim 29, further comprising said computer implemented program routing said telephone communication through the least cost route.

43. A system as in claim 42, wherein said computer implemented program uses the location of said destination phone device as an additional characteristic of said provider to determine said least cost route.
